(19) United States
(12) Patent Application Publication
(10) Pub. No.: US 2016/0283506 A1
(43) Pub. Date: Sep. 29, 2016

(54) ON-THE-FLY DEDUPLICATION DURING DATA MOVEMENT FOR NoSQL DATA STORES

(71) Applicant: Datos IO Inc., San Jose, CA (US)

(72) Inventors: Maohua Lu, Fremont, CA (US); Ajaykrishna Raghavan, Santa Clara, CA (US); Pin Zhou, San Jose, CA (US); Prasenjit Sarkar, Los Gatos, CA (US)

(21) Appl. No.: 15/057,597

(22) Filed: Mar. 1, 2016

Related U.S. Application Data
(60) Provisional application No. 62/137,294, filed on Mar. 24, 2015.

(51) Int. Cl. G06F 17/30

(52) U.S. Cl. CPC G06F 17/30156; G06F 17/30079; G06F 17/30589

(57) ABSTRACT

Embodiments disclosed herein provide systems, methods, and computer readable media for on-the-fly deduplication during movement of NoSQL data. In a particular embodiment, a method provides identifying first data items from files in a NoSQL data store and identifying duplicate data items from the first data items. The method further provides deduplicating and repackaging each of the duplicate data items into respective deduplicated data units and transferring the deduplicated data units to a secondary data repository.

### RELATED APPLICATIONS

This application is related to and claims priority to U.S. Provisional Patent Application 62/137,294, titled “ON-THE-FLY DEDUPLICATION DURING DATA MOVEMENT FOR NoSQL DATA STORES,” filed Mar. 24, 2015, and which is hereby incorporated by reference in its entirety.

### TECHNICAL BACKGROUND

NoSQL data stores, such as Cassandra and Mongo, store redundant data to protect from storage node or storage site failures. When moving data from a NoSQL data store to a secondary data repository, as may occur when backing up the data, it is inefficient to move more than one copy of the redundant data across a network. While files stored in NoSQL data store may not be identical, those files may include duplicate data items. Thus, moving files that are not identical to a secondary data repository may still be inefficiently moving copies of duplicate data items.

### OVERVIEW

Embodiments disclosed herein provide systems, methods, and computer readable media for on-the-fly deduplication during movement of NoSQL data. In a particular embodiment, a method provides identifying first data items from files in a NoSQL data store and identifying duplicate data items from the first data items. The method further provides deduplicating and repackaging each of the duplicate data items into respective deduplicated data units and transferring the deduplicated data units to a secondary storage volume.

### BRIEF DESCRIPTION OF THE DRAWINGS

FIG. 1 illustrates a computing environment for performing on-the-fly deduplication during movement of NoSQL data.

FIG. 2 illustrates an operation of the computing environment for performing on-the-fly deduplication during movement of NoSQL data.

FIG. 3 illustrates another operation of the computing environment for performing on-the-fly deduplication during movement of NoSQL data.

FIG. 4 illustrates a transfer planning system for op performing on-the-fly deduplication during movement of NoSQL data.

### DETAILED DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

Deduplicating NoSQL data prior to transferring the data to a secondary repository reduces the network resources that will be unnecessarily used should multiple copies of the same data be transferred. This is true regardless of how the data is used in the secondary repository (e.g. backup or otherwise). Moreover, deduplicating NoSQL data provides the added benefit of reducing the storage space needed in the secondary repository to save multiple copies of the same data.

Typically, data deduplication is performed at the file level. That is, multiple files must be identical in their entirety in order to take advantage of file level data deduplication. In the case of NoSQL systems, files in a NoSQL data store are less likely to be entirely identical while still containing duplicate data items therein. Accordingly, the embodiments described below are directed to deduplicating data items contained within files in a NoSQL data store.

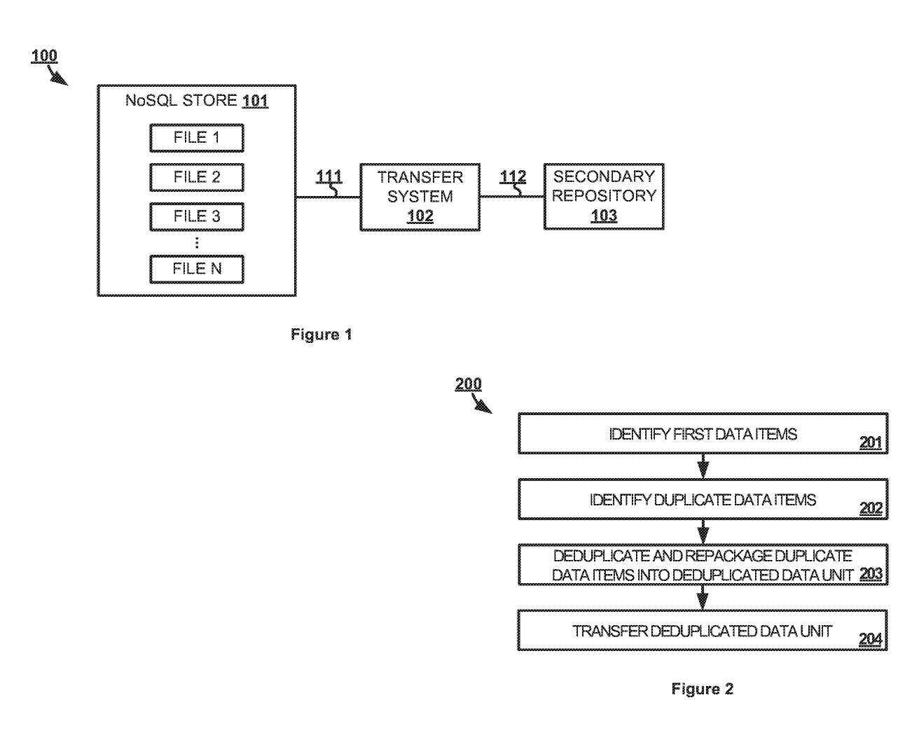

FIG. 1 illustrates computing environment 100 in an example scenario of on-the-fly deduplication during movement of NoSQL data. Computing environment 100 includes NoSQL data store 101, data transfer system 102, and secondary data repository 103. NoSQL data store 101 and data transfer system 102 communicate over communication link 111. Data transfer system 102 and secondary data repository 103 communicate over communication link 112.

In operation, data transfer system 102 is configured to control the transfer of NoSQL data between NoSQL data store 101 and secondary repository 103. The data may be transferred periodically, at set times, upon certain conditions being met, upon manual instruction of a user, or for some other reason. Data transfer system 102 deduplicates data items before the data items are transferred to secondary repository 103. While illustrated as an intermediate system between NoSQL data store 101 and secondary data repository 103, data transfer system 102 may be incorporated into NoSQL data store 102 or otherwise not in the data path between NoSQL data store 101 and secondary data repository 103. For example, each of elements 101-103 may communicate with each other through one or more communication networks, such as local area networks, wide area networks, and the Internet. Additionally, while NoSQL data store 101 is illustrated as a single element, NoSQL data store 101 may comprise multiple nodes and may be distributed across multiple physical storage systems.

FIG. 2 illustrates operation 200 of computing environment 100 for performing on-the-fly deduplication during movement of NoSQL data. Operation 200 provides that data transfer system 102 identifies first data items from files 1-N in NoSQL data store 101 (step 201). The first data items may be any type of information that is capable of being stored in a file, such as table entries, records, media, and the like, and each file may contain any number of data items. The first data items may comprise all of the data items stored in files 1-N or may be only a portion of the data items stored in files 1-N. For example, if the data items in files 1-N are being protected (e.g. backed up), then the first data items may comprise only data items that have changed since a previous backup.

Data transfer system 102 identifies duplicate data items from the first data items (step 202). The duplicate data items may be identified by comparing each of the first data items against other ones of the first data items, by comparing hashes of each of the first data items against hashes of the other ones of the first data items, or by some other means of identifying duplicate data items.

Data transfer system 102 then deduplicates and repackage, or directs NoSQL data store 101 to deduplicate and repackage, each of the duplicate data items into respective deduplicated data units (step 203). Each deduplicated data unit comprises a data form that at least contains both a single instance of the deduplicated data item and information describing the multiple locations (e.g. particular files, position within files, etc.) from which the deduplicated data item originated in NoSQL data store 101. The information can then be used should the deduplicated data item need to be restored, or otherwise, accessed from secondary repository in one of its original file locations in files 1-N.

After generating the deduplicated data units, data transfer system 102 transfers the deduplicated data units to secondary data repository 103 (step 204). In examples where data transfer system 102 is not in the data transfer path between NoSQL data store 101 and secondary data repository 103, data transfer system 102 directs NoSQL data store 101 to transfer the deduplicated data units to secondary data repository 103. Other unique, non-deduplicated data items of the first data items are also transferred to secondary data repository 103. In some cases, the both the unique data items of the first data items and the deduplicated data units are organized into a file and that file is what is transferred to secondary data repository 103. Each deduplicated data unit may include one or more deduplicated data items.

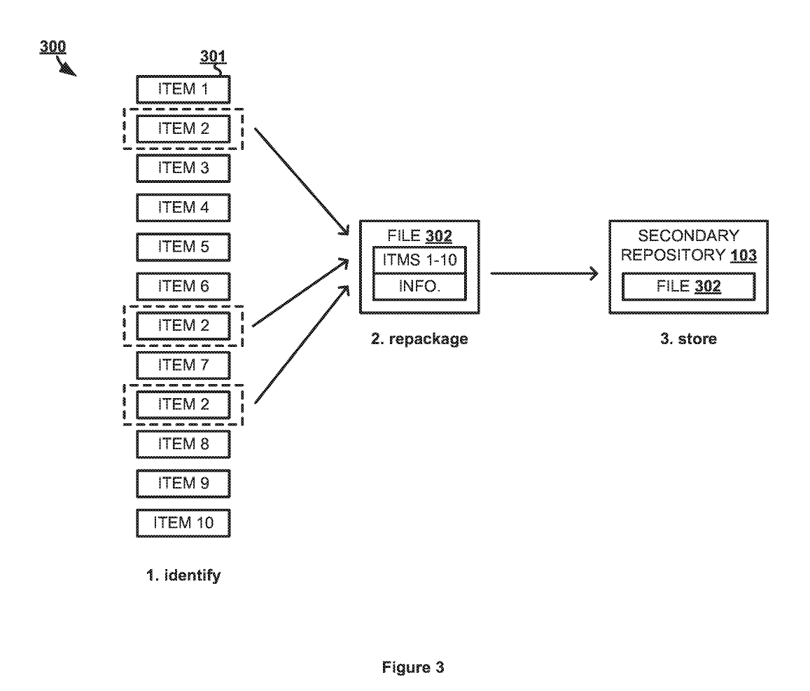

FIG. 3 illustrates operation 300 of computing environment 100 for performing on-the-fly deduplication during movement of NoSQL data. In operation 300, 12 data items have been extracted from files 1-N in NoSQL data store 101 with 10 of those data items being unique. For example, if files 1-N are part of a Cassandra database, then each of files 1-N are parsed to extract the 10 individual items. Each file may correspond to and include only 1 data item, although, files in Cassandra can include multiple data items. Thus, it is possible for a single file to include all the data items in FIG. 3. Alternatively, if files 1-N are part of a Mongo database, then the data items within two or more files may all be identical at substantially the same time (e.g. even if at one instant one of the files has more or less data items, the other file(s) will eventually catch up). In these cases where files and data items therein are identical, the deduplication process need only look at whether the files themselves are identical to determine that the data items therein are also identical.

At step 1, duplicate data items within the 12 extracted data items are identified. In this example, there are three duplicate instances of data item 2. These duplicate instances may be from the same file or may be from different files Likewise, the multiple instances of data item 2 may be stored across multiple nodes of NoSQL data store 101. Thus, information regarding duplicate item 2 is exchanged among the data store nodes to determine whether the degree of duplicates reaches a pre-defined consistency level. That is, if the duplicates do not reach the predefined consistency level, then they are not deduplicated. However, if the consistency level is met, then the operation continues as follows. To distribute the work need to determine the degree of duplicates, data may be partitioned based on keys and each data store node may be owners of one or more partitions. Collecting copies of the same data items (e.g. data item 2) is performed to determine whether enough copies are present in NoSQL data store 101 to warrant deduplication. That is, the resources needed to transfer and store the number of copies in secondary data repository 103 are balanced with the time and resources needed to deduplicate those duplicate data items.

Should the number of duplicate data items 2 be enough to warrant deduplication, step 2 repackages the deduplicated data items into a deduplicated data form. Specifically, found duplicates are removed and re-organize the remaining unique data items into file 302, which includes the remaining unique data items and any information needed to restore each copy of item 2. In other examples, the unique data items may be organized into more than one file. For a Cassandra database, step 2 repackages the remaining unique items (e.g. deduplicated items 1 and 3-10 along with deduplicated item 2) into SSTables. A Mongo database does not require similar repackaging after deduplicating a data item. Once the items have been packaged into file 302, file 302 is transferred to and stored in secondary data repository 103 at step 3.

Referring back to FIG. 1, data transfer system 102 comprises a computer system and communication interface. Data transfer system 102 may also include other components such as a router, server, data storage system, and power supply. Data transfer system 102 may reside in a single device or may be distributed across multiple devices. Data transfer system 102 could be an application server(s), a personal workstation, or some other network capable computing system—including combinations thereof. While shown separately, all or portions of data transfer system 102 could be integrated with the components of NoSQL data store 101.

NoSQL data store 101 comprise one or more data storage systems having one or more non-transitory storage medium, such as a disk drive, flash drive, magnetic tape, data storage circuitry, or some other memory apparatus. The data storage systems may also include other components such as processing circuitry, a network communication interface, a router, server, data storage system, and power supply. The data storage systems may reside in a single device or may be distributed across multiple devices.

Secondary data repository 103 comprises one or more data storage systems having one or more non-transitory storage medium, such as a disk drive, flash drive, magnetic tape, data storage circuitry, or some other memory apparatus. The data storage systems may also include other components such as processing circuitry, a network communication interface, a router, server, data storage system, and power supply. The data storage systems may reside in a single device or may be distributed across multiple devices.

Communication links 111 and 112 could be internal system busses or use various communication protocols, such as Time Division Multiplex (TDM), Internet Protocol (IP), Ethernet, communication signaling, Code Division Multiple Access (CDMA), Evolution Data Only (EVDO), Worldwide Interoperability for Microwave Access (WIMAX), Global System for Mobile Communication (GSM), Long Term Evolution (LTE), Wireless Fidelity (WIFI), High Speed Packet Access (HSPA), or some other communication format—including combinations thereof. Communication links 111 and 112 could be direct links or may include intermediate networks, systems, or devices.

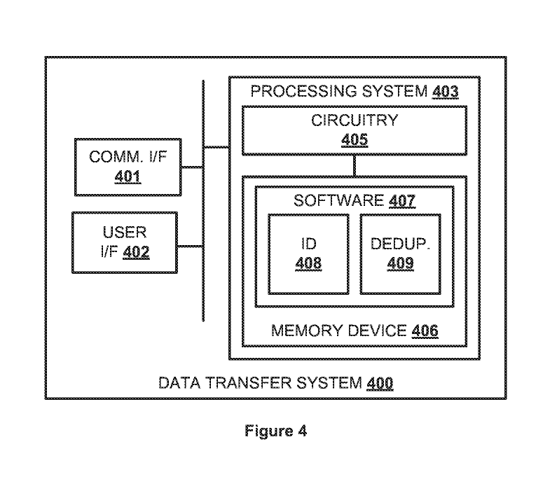

FIG. 4 illustrates data transfer system 400. Data transfer system 400 is an example of data transfer system 102, although system 102 may use alternative configurations. Data transfer system 400 comprises communication interface 401, user interface 402, and processing system 403. Processing system 403 is linked to communication interface 401 and user interface 402. Processing system 403 includes processing circuitry 405 and memory device 406 that stores operating software 407.

Communication interface 401 comprises components that communicate over communication links, such as network cards, ports, RF transceivers, processing circuitry and software, or some other communication devices. Communication interface 401 may be configured to communicate over metallic, wireless, or optical links. Communication interface 401 may be configured to use TDM, IP, Ethernet, optical networking, wireless protocols, communication signaling, or some other communication format—including combinations thereof.

User interface 402 comprises components that interact with a user. User interface 402 may include a keyboard, display screen, mouse, touch pad, or some other user input/output apparatus. User interface 402 may be omitted in some examples.

Processing circuitry 405 comprises microprocessor and other circuitry that retrieves and executes operating software 407 from memory device 406. Memory device 406 comprises a non-transitory storage medium, such as a disk drive, flash drive, data storage circuitry, or some other memory apparatus. Operating software 407 comprises computer programs, firmware, or some other form of machine-readable processing instructions. Operating software 407 includes data identification module 408 and data deduplication module 409. Operating software 407 may further include an operating system, utilities, drivers, network interfaces, applications, or some other type of software. When executed by circuitry 405, operating software 407 directs processing system 403 to operate Data transfer system 400 as described herein.

In particular, data identification module 408 directs processing system 403 to identify first data items from files in a NoSQL data store and identify duplicate data items from the first data items. Data deduplication module 409 directs processing system 403 to deduplicate and repackage each of the duplicate data items into respective deduplicated data units. Data deduplication module 409 further directs processing system 403 to transfer the deduplicated data units to a secondary data repository.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A computer readable storage medium having instructions stored thereon that, when executed by a data processing system, direct the data processing system to perform a method of on-the-fly deduplication during movement of NoSQL data, the method comprising:
identifying first data items from files in a NoSQL data store;
identifying duplicate data items and checking for consistency requirement from the first data items;
deduplicating and repackaging each of the duplicate data items into respective deduplicated data units; and
transferring the deduplicated data units to a secondary data repository.
